(19) United States
(12) Patent Application Publication
(10) Pub. No.: US 2024/0327236 A1
(43) Pub. Date: Oct. 3, 2024

(54) CORE-SHELL STRUCTURE PARTICLE, DIELECTRIC COMPOSITION, AND METHOD OF MANUFACTURING THE CORE-SHELL STRUCTURE PARTICLE

(71) Applicants: SAMSUNG ELECTRO-MECHANICS CO., LTD., Suwon-si (KR); IBARAKI UNIVERSITY, Mito (JP)

(72) Inventors: Ken Yamaguchi, Yokohama-shi (JP); Toshihiro Doi, Yokohama-shi (JP); Kotaro Hata, Yokohama-shi (JP); Koichi Nakashima, Hitachi-shi (JP)

(73) Assignees: SAMSUNG ELECTRO-MECHANICS CO., LTD., Suwon-si (KR); IBARAKI UNIVERSITY, Mito (JP)

(21) Appl. No.: 18/598,490

(22) Filed: Mar. 7, 2024

(30) Foreign Application Priority Data
Mar. 27, 2023 (JP) 2023-050101
Aug. 28, 2023 (KR) 10-2023-0112727

(51) Int. Cl. C01G 23/00; B82Y 30/00

(52) U.S. Cl. CPC C01G 23/006; B82Y 30/00; C01P 2004/64; C01P 2004/84; C01P 2006/40

(57) ABSTRACT

A core-shell structure particle may include: a core particle including BaTiO₃ having a particle size of 100 nm or less; and a shell phase including at least one of CaTiO₃ and SrTiO₃ and surrounding the core particle at a thickness of 1 unit or more and 10 units or less of a perovskite structure.

### CROSS-REFERENCE TO RELATED APPLICATION(S)

This application claims benefit of priority to Japan Patent Application No. 2023-050101 filed on Mar. 27, 2023 in the Japan Patent Office and Korean Patent Application No. 10-2023-0112727 filed on Aug. 28, 2023 in the Korean Intellectual Property Office, the disclosures of which are incorporated herein by reference in their entirety.

### TECHNICAL FIELD

The present disclosure relates to a core-shell structure particle, a dielectric composition, and a method of manufacturing the core-shell structure particle.

BaTiO₃ nanocrystals have been used as a material for forming a dielectric layer of MLCC, and have also been widely used in a Random Access Memory (RAM) and a Thermistor. Currently, an increase in capacity per unit volume and an increase in the number of MLCCs of products are thought to be main reasons for the market expansion of MLCC. Accordingly, research into various dielectric materials has been conducted to improve the capacitance of a dielectric layer of the MLCC. Therefore, it is time when new applications of BaTiO₃, which has been commercialized and used stably for a long time, are also needed. The utilization of BaTiO₃ in the MLCC is to sinter a synthesized spherical BaTiO₃ particle to form a dielectric layer, and in the new application, research and review of a new type of MLCC, which leads to changes in the particle shape, arrangement changes before sintering, and microstructure after sintering, are being conducted in various directions.

### SUMMARY

An aspect of the present disclosure is to provide dielectric particles having a high dielectric constant by forming cube or rectangular parallelepiped shaped dielectric particles.

However, the aspects of the present disclosure are not limited to the above-described contents, and may be more easily understood in the process of describing specific embodiments of the present disclosure.

According to a first aspect of the present disclosure, a core-shell structure particle may include: a core particle including BaTiO₃ having a particle size of 100 nm or less; and a shell phase including at least one of CaTiO₃ and SrTiO₃ and surrounding the core particle at a thickness of 1 unit or more and 10 units or less of a perovskite structure.

According to a second aspect of the present disclosure, provided is a dielectric composition including the core-shell structure particles.

According to a third aspect of the present disclosure, provided is a method of manufacturing the core-shell structure particle, including: a core generation operation of generating the core particle by performing solvothermal synthesis on raw materials including barium hydroxide hydrate, titanium oxide, and a first solvent under at least one of a high-temperature condition and a high-pressure condition; and a shell generation operation of generating the shell phase surrounding the core particle, by performing at least one of solvothermal synthesis and hydrothermal synthesis on at least one of the core particle, Ca hydroxide, and Sr hydroxide, and a second solvent, under at least one of a high-temperature condition and a high-pressure condition.

On the other hand, an outline of the present disclosure does not list all the features of the present disclosure. In addition, a sub-combination of these feature groups may also be an invention.

One of various effects of the present disclosure is to improve a dielectric constant of dielectric particles by forming cubic or rectangular parallelepiped-shaped dielectric particles.

Advantages and effects of the present application are not limited to the foregoing content and may be more easily understood in the process of describing a specific example embodiment of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 illustrates an embodiment of a core-shell structure particle in the present embodiment;

FIG. 2 illustrates an enlarged view of part A of FIG. 1;

FIG. 3 illustrates an embodiment of a dielectric composition according to the present embodiment;

FIG. 4 illustrates an embodiment of a manufacturing process of core-shell structure particles in the present embodiment;

FIG. 5 illustrates an example of core particles after a core generation operation;

FIG. 6A illustrates an observation image of a core particle by HAADF-STEM, and FIG. 6B illustrates an observation image of a core particle by HAADF-STEM;

FIG. 7A illustrates an observation image of a core-shell structure particle by HAADF-STEM, and FIG. 7B illustrates image an observation image of a core-shell structure particle by HAADF-STEM;

FIG. 8A illustrates an observation image of a core-shell structure particle by HAADF-STEM, and FIG. 8B illustrates an observation image of a core-shell structure particle by HAADF-STEM;

FIG. 9 illustrates a TEM-EDS observation imaging of a core-shell structure particle in which a shell phase is CaTiO₃;

FIG. 10 illustrates an enlarged image of FIG. 9;

FIG. 11 illustrates a TEM-EDS observation image of a core-shell structure particle in which a shell phase is SrTiO₃; and

FIG. 12 shows an enlarged image of FIG. 11.

### DETAILED DESCRIPTION

Hereinafter, the present disclosure will be described through embodiments of the present disclosure, but the following embodiments do not limit the invention according to the claims. In addition, not all combinations of features described in the embodiments are essential to the solution of the invention.

### [1] A Core-Shell Structure Particle:

A Core-shell structure particle according to the present embodiment will be described.

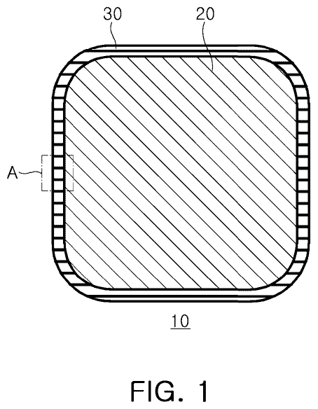

FIG. 1 illustrates an embodiment of a core-shell structure particle 10 in the present embodiment. In this embodiment, the core-shell structure particle 10 may include a core particle 20 and a shell phase 30.

The core particle 20 may include barium titanate (BaTiO₃), and the core particle 20 may be a crystal of BaTiO₃.

The core particle 20 may have a cubic shape, a rectangular parallelepiped shape, a polyhedron, a cylinder, a sphere, an ellipse, an irregular shape, or other shapes. The core particle 20 may have a cubic shape or a rectangular parallelepiped shape. In this case, corner portions and/or side portions of the cube shape and the rectangular parallelepiped shape need not be straight and may be round.

Specifically, when the core particle 20 in the cube shape and the rectangular parallelepiped shape are mixed with barium titanate particles, an area of an interface in which surfaces of heterogeneous particles are in contact with each other may increase. As a result, it may be possible to increase a relative dielectric constant of dielectric ceramics manufactured from the core-shell structure particles 10. Even if the core particle 20 do not have a cube shape or a rectangular parallelepiped shape, there is no change in generating an interface in which surfaces of heterogeneous particles are in contact with each other, and thus, the shape of the core particle 20 is not limited to the cube shape or the rectangular parallelepiped shape.

A particle size (e.g., a diameter or a side length) of the core particle 20 may be 100 nm or less, preferably 60 nm or less, and more preferably 45 nm or less. When the particle size is satisfied, a size of the electric component manufactured using the core-shell structure particle 10 may be reduced. Furthermore, since an interface area per unit weight increases, the relative dielectric constant may be increased.

When the core particle 20 have the cube shape or the rectangular parallelepiped shape, the particle size may be an average value or a median value of a length of one side of a cube or a long side of a rectangular parallelepiped observed by a scanning electron microscope (SEM). When the core particle 20 are spherical, elliptical, or irregular, the particle size may be an average value or a median value of a length of a long side observed with a scanning electron microscope (SEM). Alternatively, a size of the core particle 20 may be an average size measured by a laser diffraction particle size distribution meter.

There is no particular limitation on a method of manufacturing the core particle 20, and the core particle 20 may be manufactured by various conventional methods. As described below, the core particle 20 having a cubic shape may be manufactured using solvothermal synthesis.

Here, the term “solvothermal synthesis” may denote a reaction performed under high temperature and high pressure, and specific temperature and pressure conditions will be described below, but the present disclosure is not particularly limited to the temperature and pressure conditions described below.

The shell shape 30 may surround or cover the core particle 20. The shell shape 30 may surround an entire surface of the core particle 20. Alternatively, the shell shape 30 may partially surround a portion of the surface of the core particle 20.

The shell phase 30 may be a compound in which barium of barium titanate is substituted with a group 2 element. For example, the shell phase 30 includes CaTiO₃ and/or SrTiO₃. The shell phase 30 may be a layer in which CaTiO₃ and SrTiO₃ are mixed.

The shell phase 30 may have a thickness of 1 unit or more and 10 units or less, more preferably 1 unit or more and 5 units or less, and more preferably 1 unit or more and 3 units or less, of a perovskite structure formed by CaTiO₃ and SrTiO₃. Here, the term “unit” may be a unit that refers to one atom.

When the thickness of the shell phase 30 is within the aforementioned range, the size of the core-shell structure particle may be suppressed to almost the same as that of the core particle 20. Accordingly, it may be possible to reduce a size of a component using dielectric ceramics including core-shell structure particles.

The shell phase may surround an entire surface of the core particle at a substantially equal thickness. In one example, the term “substantially” may refer to a concept including a minute difference caused by a process error or a measurement error. For example, “being substantially equal” may include not only a case of being “equal”, but also a case of having a minute difference caused by a process error or a measurement, recognizable by one of ordinary skill in the art. Accordingly, when mixed with heterogeneous particles such as barium titanate particles afterwards, an interface with the heterogeneous particles may be reliably formed. A state of the shell phase 30 may be observed and analyzed by a scanning transmission electron microscope (STEM) and an energy dispersive X-ray spectroscopy (EDS).

When the shell phase 30 partially surrounds the core particles 20, a thickness of a surrounding portion may denote a thickness of the shell phase 30. When the shell shape 30 entirely surrounds the core particle 20, all, an average, or a portion of a thickness of a surrounding portion may denote a thickness of the shell shape 30. Since the thickness of the shell phase 30 is significantly small as compared to a particle size of the core particle 20, a particle size of the core-shell structure particle 10 may be almost the same as a particle size of the core particle 20.

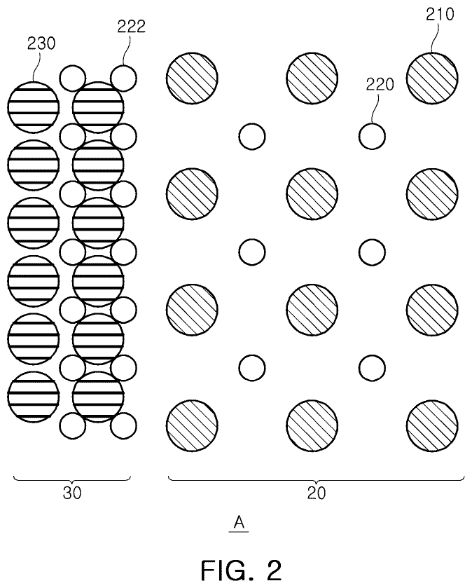

FIG. 2 illustrates an enlarged view of part A of FIG. 1. In the core particle 20, a lattice of a perovskite structure may be formed by Ba atoms 210 and Ti atoms 220, and non-illustrated oxygen (O) atoms. In the shell phase 30, a perovskite structure may be formed by Ti atoms 222 and Ca atoms or Sr atoms 230.

In FIG. 2, in the shell phase 30, the Ti atoms 222 disposed at a center of the perovskite structure exists at a thickness of two units. That is, the shell phase 30 is formed at a thickness of two units of a perovskite structure lattice.

### [2] Dielectric Composition:

A dielectric composition according to the present embodiment will be described. The dielectric composition includes the core-shell structure particles described above. The dielectric composition may include core-shell structure particles, barium titanate particles, and a binder resin. In addition, the dielectric composition may suitably include solvents and other additives as needed.

The barium titanate particle may have a cubic shape, a rectangular parallelepiped shape, a sphere, an ellipse, an irregular shape, or other shapes. The barium titanate particle may have a cubic shape or a rectangular parallelepiped shape, and in this case, corner portions and/or side portions may be round. Such a shape may increase an area of an interface in which surfaces of the particle are in contact with each other when aggregated together with the core-shell structure particles, and may thus increase a relative dielectric constant when used in a dielectric composition.

The barium titanate particle may be 100 nm or less, preferably 60 nm or less, and more preferably 45 nm or less. A definition of the particle size may be the same as a particle size of the core-shell structure particle.

The barium titanate particle may have the same shape as core-shell structure particle. For example, both the barium titanate particle and the core-shell structure particle may have a cubic shape or a rectangular parallelepiped shape. The barium titanate particle may have the same or substantially equal particle size as the core-shell structure particle. For example, the barium titanate particle may be core particle 20 excluding the shell phase 30 from the core-shell structure particle 10.

The barium titanate particle and the core-shell structure particle have the same shape and/or particle size, and thus, when a dielectric composition is subsequently sintered, both particles may be integrated in three dimensions in a block phase, and an interface between both particles may be favorably formed, thereby increasing the relative dielectric constant.

A binder resin is not particularly limited as long as it is commonly used in a dielectric composition. For example, polyvinyl alcohol, polyvinyl butyral, or acrylic resin may be used as the binder resin. The amount of the binder resin is not particularly limited, and may be, for example, 0.01 wt % or more and 20 wt % or less, preferably 0.5 wt % or more and 15 wt % or less, based on a total amount of the barium titanate particles and the core-shell structure particles. Accordingly, it may be possible to improve the density of dielectric ceramics to be formed later while maintaining formability.

Dielectric ceramics may be generated by stacking a dielectric composition formed by press-molding or sheet-molding into a predetermined shape and then performing a debinder treatment thereon. The debinder treatment may be, for example, a heat treatment, and may be a heat treatment at 300° C. or more and 800° C. or less, and preferably, 400° C. or more and 600° C. or less.

The dielectric ceramics of the present embodiment may be used for various applications requiring high dielectric constant. For example, the dielectric ceramics may be used as dielectrics for a condenser that is an electronic component. Specifically, the dielectric ceramics may be suitably used as a condenser for a power device substrate or a condenser for a power substrate.

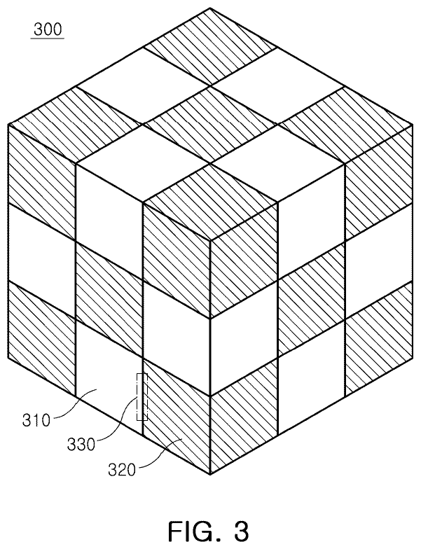

FIG. 3 illustrates an example of dielectric ceramic 300 according to the present embodiment. The dielectric ceramic 300 of the present embodiment may have a structure in which barium titanates 310 and core-shell structures 320 are aggregated to form an interface with each other. The barium titanate 310 is formed from barium titanate particle. The core-shell structure 320 is formed from core-shell structure particle.

For example, as illustrated, the barium titanate 310 may have a cubic shape derived from a shape of barium titanate particles, and the core-shell structure 320 may also have a cubic shape derived from a shape of core-shell structure particles. Blocks derived from these particles are regularly overlapped and three-dimensionally integrated. An interface 330 is formed between a portion of the core-shell structure 320 corresponding to a shell phase made of CaTiO₃ and/or SrTiO₃ and the barium titanate 310.

At the interface 330 between the barium titanate 310 and the core-shell structure 320, it is estimated that a crystal lattice is distorted, and a huge dielectric constant is expressed. The dielectric ceramic 300 of the present embodiment may express a very high dielectric constant by having many fine interfaces as described above, and may also have excellent DC bias characteristics.

Meanwhile, FIG. 3 illustrates an example of a structure in which heterogeneous particles are adjacent. Specifically, the dielectric ceramic 300 are formed by a random set of homogeneous and heterogeneous particles, and may include cases in which adjacent particles are homogeneous.

### [3] A Method of Manufacturing a Core-Shell Structure Particle:

A method of manufacturing the core-shell structure particle according to the present embodiment will be described.

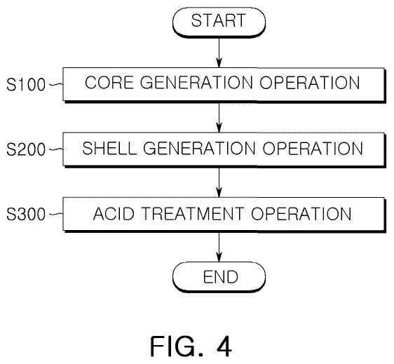

FIG. 4 illustrates an embodiment of a manufacturing process of the core-shell structure particles in the present embodiment. The core-shell structure particles may be manufactured by treatment from S100 to S300. A portion of S300 from S100 may be omitted. Other processing may be executed in addition to S300 from S100.

First, in S100, a core generation operation is performed. In the core generation operation, core particles may be generated by performing solvothermal synthesis. For example, the solvothermal synthesis may be performed by placing raw materials including barium hydroxide hydrate, titanium oxide, and a first solvent under high temperature and/or high pressure.

The barium hydroxide hydrate may be an octahydrate (Ba(OH)₂·8H₂O). However, the present disclosure is not particularly limited thereto, and other hydrates such as monohydrates (Ba(OH)₂·1H₂O), or anhydride may be used in place of the octahydrate (Ba(OH)₂·8H₂O).

In a titanium oxide, there are an anatase type, a rutile type, and a brookite type, among which an anatase type may be preferable. The titanium oxide may have a particle size of 100 nm or less, preferably 50 nm or less, and more preferably 25 nm or less, in a laser diffraction particle size distribution meter measurement or a long side measurement by SEM. The titanium oxide may be used in a range of 10 moles or more and 100 moles or less, preferably 20 moles or more and 50 moles or less, based on 100 moles of the barium hydroxide hydrate.

The first solvent may be selected from water or alcohol. The alcohol may be selected from methanol, ethanol, 1-propanol, 1-butanol, and the like. An amount of the first solvent may be 10 parts by weight or more and 2000 parts by weight or less, preferably 100 parts by weight or more and 1000 parts by weight or less, based on 100 parts by weight of the solid content.

As an additional raw material, titanium alkoxide may be included. For example, titanium alkoxide may be titanium tetraisopropoxide ([(CH₃)₂CHO]₄Ti). The titanium alkoxide may be used in a range of 3 moles or more and 30 moles or less, preferably 5 moles or more to 20 moles or less, based on 100 moles of the barium hydroxide hydrate.

The raw material may be placed in a sample container, and the raw material may be mixed. Then, the sample container may be placed in a high-pressure reaction decomposition container. Then, the high-pressure reaction decomposition container is installed in a heating device and heated in the heating device to perform solvothermal synthesis.

The heating in the solvothermal synthesis may be performed at a temperature of 100° C. or more and 300° C. or less, preferably 150° C. or more and 250° C. or less, more preferably 180° C. or more and 220° C. or less. Heating in the solvothermal synthesis may be performed for 5 hours or more and 100 hours or less, preferably 50 hours or more and 90 hours or less, and more preferably 70 hours or more and 80 hours or less.

A product may be obtained by performing separation, cleaning, and drying operations on a compound obtained by the solvothermal synthesis. The product obtained through the solvothermal synthesis may be crystal particles of barium titanate in a cubic shape or a rectangular parallelepiped shape. A product after the core generation operation may be a core particle portion in the core-shell structure particle. Furthermore, a product after the core generation operation may be used as barium titanate particle of the dielectric composition.

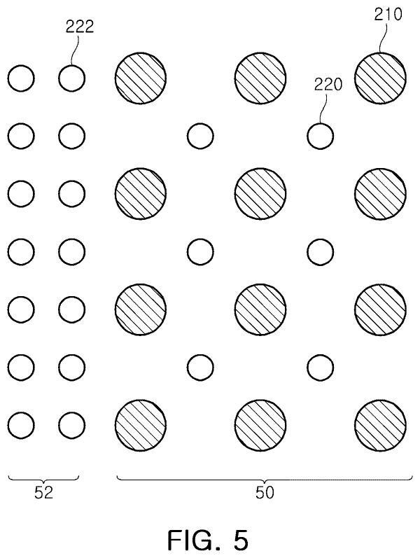

FIG. 5 illustrates an embodiment of core particle after the core generation operation. FIG. 5 illustrates an enlarged state of a surface of the core particle as illustrated in part A of FIG. 1. A perovskite structure of barium titanate may be formed in an internal portion 50 of the core particle. On the other hand, in an external portion 52 of the core particle, the Ba atoms 210 may not exist, and the Ti atoms 222 may be precipitated.

Next, in S200, a shell generation operation is performed. In the shell generation operation, solvothermal synthesis or hydrothermal synthesis may be performed to generate a shell phase covering the core particle. For example, by placing core particle, group 2 hydroxides, and a second solvent generated in S100 under a high temperature and/or high pressure, the solvothermal synthesis or the hydrothermal synthesis may be performed. High pressure, for instance, may refer to a pressure level higher than an atmospheric pressure.

The group 2 hydroxide may include at least one of a Ca hydroxide (Ca(OH)₂) and a Sr hydroxide (Sr(OH)₂), but is not particularly limited thereto and may include other group 2 hydroxides. Based on 100 moles of the core particles, the group 2 hydroxide may be included in 10 moles or more and 1000 moles or less, preferably 50 moles or more and 300 moles or less, and more preferably 100 moles or more and 150 moles or less. The group 2 hydroxide may be 10 parts by weight or more and 90 parts by weight or less, based on 100 parts by weight of the addition amount of core particles.

The second solvent may be selected from water or alcohol. The alcohol may be selected from methanol, ethanol, 1-propanol, 1-butanol, and the like. An amount of the second solvent may be 10 parts by weight or more and 2000 parts by weight or less, preferably 500 parts by weight or more and 1500 parts by weight or less, based on 100 parts by weight of the solid content.

The raw material may be placed in a sample container, and the raw material may be mixed. Then, the sample container may be placed in a high-pressure reaction decomposition container. Then, the high-pressure reaction decomposition container is installed in a heating device and heated in the heating device to perform solvothermal synthesis or hydrothermal synthesis.

The heating in the solvothermal synthesis or the hydrothermal synthesis may be performed at a temperature of 100° C. or more and 300° C. or less, preferably 100° C. or more and 200° C. or less, and more preferably 100° C. or more and 150° C. or less. The heating in the solvothermal synthesis or the hydrothermal synthesis may be performed for 5 hours or more and 100 hours or less, preferably 7 hours or more and 30 hours or less, more preferably 10 hours or more and 20 hours or less.

A product may be obtained by separating, washing, and drying the compound obtained by the solvothermal synthesis or the hydrothermal synthesis. The product obtained through the solvothermal synthesis or the hydrothermal synthesis becomes particles in which a shell phase derived from group 2 hydroxide is formed on a surface of the core particle. Specifically, the group 2 hydroxide may react to an external portion 52 of FIG. 5 to form a shell-shaped perovskite structure (CaTiO₃ or SrTiO₃).

Next, in S300, an acid treatment operation is performed. In the acid treatment step, the product obtained in the shell generation operation of S200 may be acid-treated. For example, an acid is added to the product of S200 and is stirred. As the acid, a weak acid aqueous solution such as acetic acid may be used. For example, an aqueous solution of 1 volume % or more and 10 volume % or less of acetic acid may be used as an acid for acid treatment. Based on the composition, an acid of 1 part by weight or more and 100 parts by weight or less, preferably 20 parts by weight or more and 70 parts by weight or less may be used. After acid treatment, the product may be separated, washed, and stirred. The purpose of the acid treatment is to wash unreacted Ca or Sr, but the acid treatment may be omitted. Even without an acid treatment operation, core-shell structure particles may be prepared.

As described above, according to the present disclosure, core-shell structure particles may be generated by S100 to S300. Specifically, according to the present embodiment, it may be possible to generate core-shell structure particles without requiring large costs or time. In addition, according to the present embodiment, the core-shell structure particles may be manufactured on a relatively large scale. Accordingly, this may greatly contribute to mass production of core-shell structure particles, dielectric compositions using the same, and dielectric ceramics.

The core particles manufactured in S100 may be used as barium titanate particles, and may be used in the dielectric composition together with the core-shell structure particles manufactured in S300. In this case, the acid treatment step of S300 may be applied to the core particles manufactured in S100.

### Example Embodiment

Hereinafter, example embodiments of the present disclosure will be described, but the technical scope of the present disclosure is not limited to the following examples.

### Example 1: Manufacture of Core Particles

The following raw materials were placed in 100 mL of a sample container made of polytetrafluoroethylene (PTFE), and stirred (350 rpm, for 5 minutes).
Ba(OH)₂·8H₂O: 20 mmol (6.3 g),
TiO₂ (particle diameter <25 nm, polytype, anatase type) 7.5 mmol (0.60 g),
[(CH₃)₂CHO]₄Ti: 2.5 mmol (0.71 g), and
1-Butanol: 40 mL

Next, a sample container made of polytetrafluoroethylene (PTFE) was placed in a high-pressure reaction decomposition container (Sanai Science Co., Ltd., HUT-100). Furthermore, a high-pressure reaction decomposition container was placed in a dryer, and heating was performed. The heating conditions were temperature: 200° C. and time: 72 hours.

Next, with respect to a composite after heating, water was used as a solvent, and centrifugation for 5 minutes at 10,000 rpm was repeated three times. Then, methanol was used as a solvent, and centrifugation for 5 min at 10,000 rpm was repeated twice. The separated solids were dried at 80° C. overnight.

2 ml of acetic acid was placed in 50 ml of a volumetric flask, and was diluted with water to prepare 50 ml of an aqueous acetic acid solution. A dried product (1.0 g) was placed into a beaker, and stirred (350 rpm, 5 minutes) with 50 ml of the aqueous acetic acid solution.

With respect to a stirred object, water was used as a solvent, and centrifugation for 5 minutes at 10,000 rpm was repeated three times. Then, methanol was used as a solvent, and centrifugation for 5 minutes at 10,000 rpm was repeated twice. The separated solids were dried at 80° C. overnight.

When the dried product was observed with an electron microscope, surface reconstruction was formed by Ti column on a cube surface of BaTiO₃. One side of the cube was about 80 nm long. Corner portions of the cube were a little rounded.

### Example 2: Manufacturing of Core-Shell Structure Particles Including Sr

The following raw materials were placed in 100 mL of a sample container made of polytetrafluoroethylene (PTFE), and stirred (350 rpm, for 5 minutes).
Ba(OH)₂·8H₂O: 20 mmol (6.3 g),
TiO₂ (particle diameter <25 nm, polytype, anatase type): 7.5 mmol (0.60 g),
[(CH₃)₂CHO]₄Ti: 2.5 mmol (0.71 g), and
1-Butanol: 40 mL

Next, a PTFE sample container was placed in a high-pressure reaction decomposition container (Sanai Science Co., Ltd.: HUT-100). Furthermore, a high-pressure reaction decomposition container was placed in a dryer, and heating was performed. The heating conditions were temperature: 200° C., and time: 72 hours.

Next, with respect to a composite after heating, water was used as a solvent, and centrifugation for 5 minutes at 10,000 rpm was repeated three times. Then, methanol was used as a solvent, and centrifugation for 5 minutes at 10,000 rpm was repeated twice. The separated solids were dried at 80° C. overnight. Accordingly, core particles as nano-cube shaped BaTiO₃, were obtained.

Next, the following raw materials were placed in 100 mL of a sample container made of PTFE, and stirred (350 rpm, 5 minutes).
Core Particles: 8.6 mmol (2.0 g),
Sr(OH)₂: 10 mmol (1.2 g), and
Water: 40 ml

Next, a PTFE sample container was placed in a high-pressure reaction decomposition container (Sanai Science Co., Ltd.: HUT-100). Furthermore, a high-pressure reaction decomposition container was placed in a dryer, and heating was performed. The heating conditions were temperature: 100° C., and time: 12 hours.

Next, with respect to a composite after heating, water was used as a solvent, and centrifugation for 5 minutes at 10,000 rpm was repeated three times. Then, methanol was used as a solvent, and centrifugation for 5 minutes at 10,000 rpm was repeated twice. The separated solids were dried at 80° C. overnight.

2 ml of acetic acid was placed in 50 ml of a volumetric flask, and was diluted with water to prepare 50 ml of an aqueous acetic acid solution. The dried product (1.0 g) was placed into a beaker, and stirred (350 rpm, 5 minutes) with 50 ml of an aqueous acetic acid solution.

With respect to a stirred object, water was used as a solvent, and centrifugation for 5 minutes at 10,000 rpm was repeated three times. Then, methanol was used as a solvent, and centrifugation for 5 minutes at 10,000 rpm was repeated twice. The separated solids were dried at 80° C. overnight.

When the dried product was observed with a scanning electron microscope (SEM), core-shell structure particles in which the core particle was cubic of BaTiO₃ and the shell was SrTiO₃ were confirmed. The core-shell structure particles had a cube of about 80 nm on one side, and the shell phase had a thickness of 2 units of the perovskite structure. Corner portions of the cube were a little round.

### Example 3: Manufacture of Core-Shell Structure Particles Including Cal

The following raw materials were put into 100 mL of a sample container made of polytetrafluoroethylene (PTFE), and stirred (350 rpm, for 5 minutes).
Ba(OH)₂·8H₂O: 20 mmol (6.3 g),
TiO₂ (particle diameter <25 nm, polytype, anatase type): 7.5 mmol (0.60 g),
[(CH₃)₂CHO]₄Ti: 2.5 mmol (0.71 g), and 1-butanol: 40 mL

Next, a PTFE sample container was placed in a high-pressure reaction decomposition container (Sanai Science Co., Ltd.: HUT-100). Furthermore, a high-pressure reaction decomposition container was placed in a dryer, and heating was performed. The heating conditions were temperature: 200° C., and time: 72 hours.

Next, with respect to a composite after heating, water was used as a solvent, and centrifugation for 5 minutes at 10,000 rpm was repeated three times. Then, methanol was used as a solvent, and centrifugation for 5 minutes at 10,000 rpm was repeated twice. The separated solids were dried at 80° C. overnight. Accordingly, core particles as nano-cube shaped BaTiO₃, were obtained.

Next, the following raw materials were placed in a sample container made of 100 mL of polytetrafluoroethylene (PTFE), and stirred (350 rpm, 5 minutes).
Core Particles: 8.6 mmol (2.0 g),
Ca(OH)₂: 10 mmol (0.74 g), and
Water: 40 ml

Next, a PTFE sample container was placed in a high-pressure reaction decomposition container (Sanai Science Co., Ltd.: HUT-100). Furthermore, a high-pressure reaction decomposition container was placed in a dryer, and heating was performed. The heating conditions were temperature: 100° C., and time: 12 hours.

Next, with respect to a composite after heating, water was used as a solvent, and centrifugation for 5 minutes at 10,000 rpm was repeated three times. Then, methanol was used as a solvent, and centrifugation for 5 minutes at 10,000 rpm was repeated twice. The separated solids were dried at 80° C. overnight.

2 ml of acetic acid was placed in 50 ml of a volumetric flask, and was diluted with water to prepare 50 ml of an aqueous acetic acid solution. The dried product (1.0 g) was placed in a beaker, and stirred (350 rpm, 5 minutes) with 50 ml of an aqueous acetic acid solution.

With respect to a stirred object, water was used as a solvent, and centrifugation for 5 minutes at 10,000 rpm was repeated three times. Then, methanol was used as a solvent, and centrifugation for 5 minutes at 10,000 rpm was repeated twice. The separated solids were dried at 80° C. overnight.

When the dried product was observed with a scanning electron microscope, core-shell structure particles in which the core particle was cubic of BaTiO₃ and the shell was CaTiO₃ were confirmed. The core-shell structure particles had a cube of about 80 nm on one side, and the shell phase had a thickness of 2 units of the perovskite structure. Corner portions of the cube were a little round.

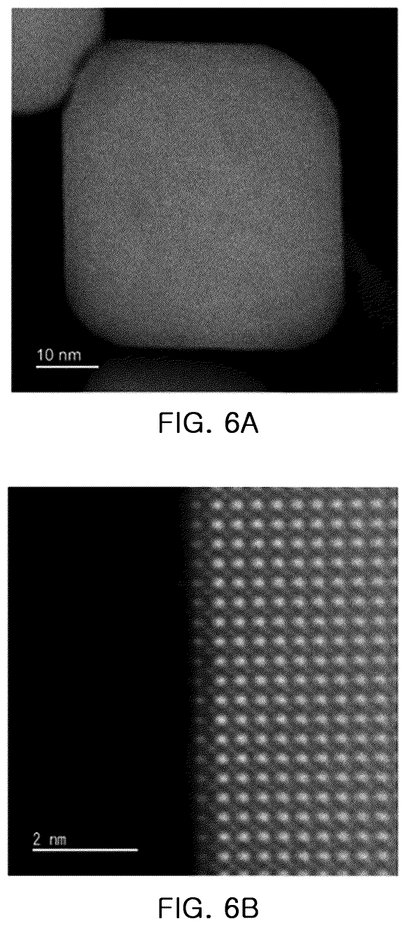

FIGS. 6A and 6B illustrate observation images by High-Angle Annual Dark Field Scanning Transmission Electron Microscopy (HAADF-STEM) of a core particle. FIG. 6A is an observation result of HAADF-STEM of the entire core particle manufactured in Example 1. FIG. 6B is an enlarged view of a portion of a left side of the core particle of FIG. 6A. As illustrated, a layer of Ti atoms (small white spots in the image or light shaded spots in the image) of two units of a perovskite structure is formed on the outside (left side of the figure).

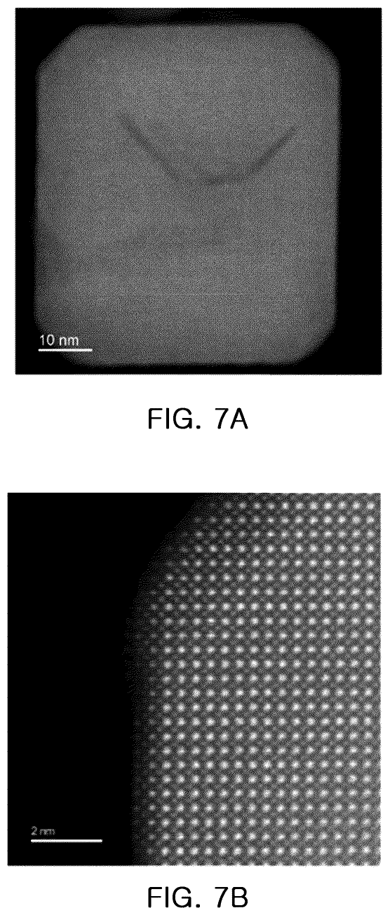

FIGS. 7A and 7B illustrate images of a core-shell structure particle observed by HAADF-STEM. FIG. 7A is an observation result of HAADF-STEM of the entire core-shell structure particle in which a shell phase manufactured in Example 2 is SrTiO₃. FIG. 7B is an enlarged view of a portion of an upper left corner of the core-shell structure particle in FIG. 7A. As illustrated, a shell shape of two units of a perovskite structure (small white spots in the image or light shaded spots in the image) is formed on the outside (left side of the figure).

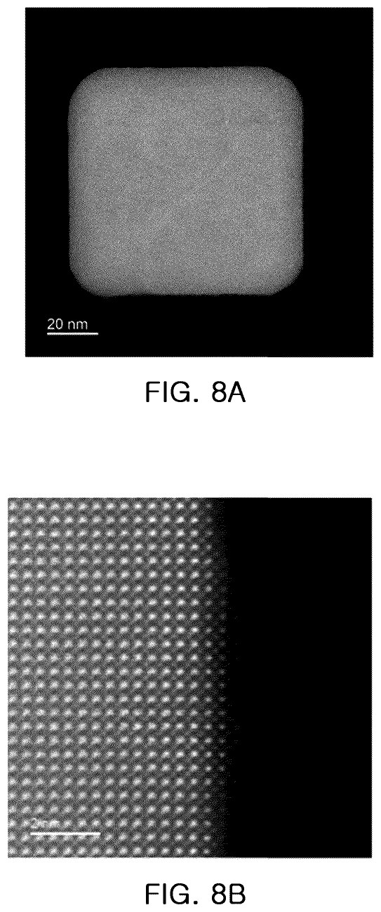

FIGS. 8A and 8B illustrate images of a core-shell structure particles observed by HAADF-STEM. FIG. 8A is an observation result of HAADF-STEM of the entire core-shell structure particle in which the shell phase manufactured in Example 3 is CaTiO₃. FIG. 8B is an enlarged view of a portion of a right side of the core-shell particle of FIG. 8A. As illustrated, a shell shape of two units of a perovskite structure (small white spots in the image or light shaded spots in the image) is formed on the outside (right side of the figure).

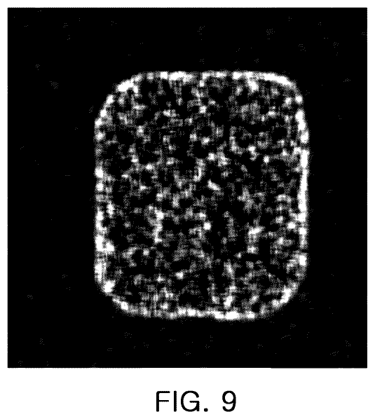

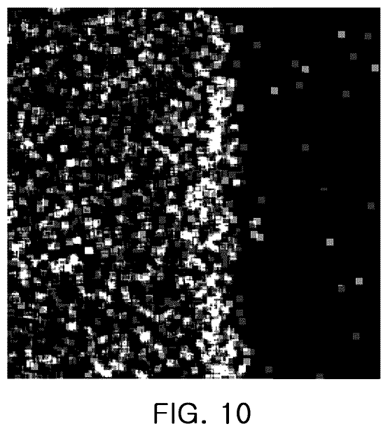

FIG. 9 illustrates an electron microscope (TEM) element analysis (EDS) observation image of a core-shell structure particle in which a shell phase is CaTiO₃. FIG. 9 is an image of an EDS elemental mapping of core-shell structure particle in which the shell phase manufactured in Example 3 is CaTiO₃. FIG. 10 is an enlarged view of a portion of FIG. 9. As illustrated, a thin shell of Ca (light white spots in the image) is formed outside the cube-shaped core particle.

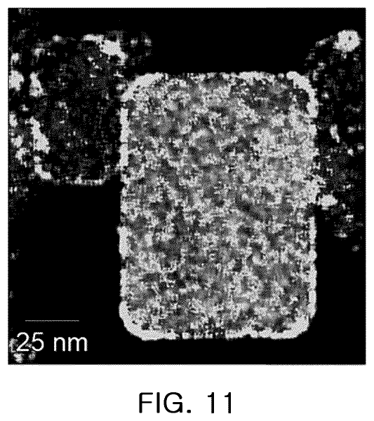

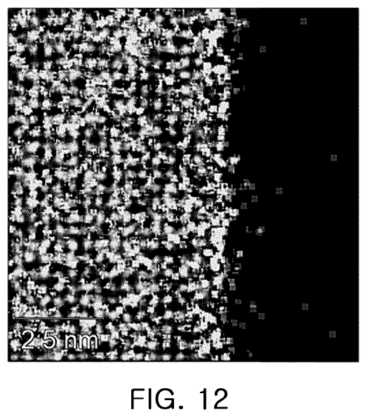

FIG. 11 illustrates an observation image of a core-shell structure particle. FIG. 11 is an image of an EDS elemental mapping (EDS elemental mapping) of the core-shell structure particle in which the shell phase manufactured in Example 2 is SrTiO₃. FIG. 12 is an enlarged view of a portion of FIG. 11. As illustrated, a thin Sr shell image is (light white spots in the image) formed outside the cube-shaped core particle.

An example of manufacturing a cube-shaped core particle using solvothermal synthesis and covering the core particle with a shell phase has been described above, but a method of manufacturing the core-shell structure particle is not limited thereto. For example, core-shell structure particle may be manufactured by covering an existing barium titanate particle with the shell phase.

As described above, while example embodiments of the present disclosure have been described, the technical scope of the present disclosure is not limited to the above-described example embodiments. It is apparent to persons skilled in the art that various alterations and improvements can be added to the above-described example embodiments. It is also apparent from the scope of the claims that the example embodiments added with such alterations or improvements can be included in the technical scope of the invention.

It should be noted that an order of execution of each process, such as an operation, a procedure, a step and a stage, in a device, a system, a program, and a method shown in the claims, the specifications, and the drawings, can be realized in any order as long as a process order is not specifically specified as “before”, “ahead”, or the like, and unless an output of previous processing is used in subsequent processing. Even if an operation flow in the scope of the claim, the specification, and the drawing are explained using “first,” “next,” etc. for convenience, it does not mean that it is essential to implement operations in this order.

What is claimed is:

1. A core-shell structure particle, comprising:
a core particle including BaTiO₃ having a particle size of 100 nm or less; and
a shell phase including at least one of CaTiO₃ and SrTiO₃ and surrounding the core particle at a thickness of 1 unit or more and 10 units or less of a perovskite structure.

2. The core-shell structure particle according to claim 1, wherein the shell phase surrounds an entire surface of the core particle at a substantially equal thickness.

3. The core-shell structure particle according to claim 1, wherein the core particle includes at least one of a cubic shape and a rectangular parallelepiped shape.

4. The core-shell structure particle according to claim 3, wherein the core particle includes at least one of the cubic shape and the rectangular parallelepiped shape in which corner portions are round.

5. A dielectric composition comprising the core-shell structure particles according to claim 1.

6. A method of manufacturing the core-shell structure particles according to claim 1, comprising:
a core generation operation of generating the core particles by performing solvothermal synthesis on a material including barium hydroxide hydrate, titanium oxide, and a first solvent, under at least one of a high-temperature condition and a high-pressure condition; and
a shell generation operation of generating the shell phase surrounding the core particles, by performing at least one of solvothermal synthesis and hydrothermal synthesis on at least one of the core particles, Ca hydroxide, and Sr hydroxide, and a second solvent, under at least one of a high-temperature condition and a high-pressure condition.

7. The method of manufacturing the core-shell structure particles according to claim 6, further comprising:
an acid treatment operation of acid-treating a product obtained in the shell generation operation.

8. The method of manufacturing the core-shell structure particles according to claim 7, wherein at least one of the solvothermal synthesis and the hydrothermal synthesis in at least one of the core generation operation and the shell generation operation is performed at a temperature of 100° C. or more and 300° C. or less for 5 hours or more and 100 hours or less.

9. The method of manufacturing the core-shell structure particles according to claim 7, wherein the first solvent and the second solvent include at least one of water and alcohol.

10. The method of manufacturing the core-shell structure particles according to claim 7, wherein an addition amount of at least one of the Ca hydroxide and the Sr hydroxide in the shell generation operation is 10 parts by weight or more and 90 parts by weight or less, based on 100 parts by weight of the addition amount of the core particles.

11. The method of manufacturing the core-shell structure particles according to claim 6, wherein the high-temperature condition refers to a temperature of 100° C. or more and 300° C. or less.

12. The method of manufacturing the core-shell structure particles according to claim 6, wherein the high-pressure condition refers to a pressure level higher than an atmospheric pressure.
